(19) United States
(12) Patent Application Publication
(10) Pub. No.: US 2006/0083240 A1
(43) Pub. Date: Apr. 20, 2006

(54) Broadcasting data over multiple dissimilar wireless networks

(75) Inventors: Christian Hofstaedter, Perkasie, PA (US); Christopher Bogdon, Cranberry Townplace, PA (US); Randy Ellison, Fogelsville, PA (US)

Correspondence Address: GREENBLUM & BERNSTEIN, P.L.C., 1950 ROLAND CLARKE PLACE, RESTON, VA, 20191, US

(73) Assignee: PADCOM, Inc., Bethlehem, PA (US)

(21) Appl. No.: 10/967,130

(22) Filed: Oct. 19, 2004

(51) Int. Cl. H04L 12/28

(52) U.S. Cl. 370/390

(57) ABSTRACT

A method is provided for broadcasting a packet over multiple dissimilar wireless networks, at least one of the networks natively supporting broadcasting and at least one of the networks not natively supporting broadcasting. The method includes determining whether the packet is to be broadcast; and when the packet should be broadcast, determining recipients of the packet. A current network over which the packet will be broadcast is then selected based upon the determined recipients. Subsequently, it is determined whether the current network supports broadcasting. When the current network does not natively support broadcasting, the packet is individually sent to each recipient over the current network. When the current network does natively support broadcasting, the packet is broadcasted to the recipients over the current network.

### CROSS REFERENCE TO RELATED APPLICATIONS

### BACKGROUND OF THE INVENTION

1. Field of the Invention

The present invention relates to the field of wireless communications. More particularly, the present invention relates to broadcasting data over dissimilar wireless networks as mobile users seamlessly roam between multiple wireless networks.

2. Background Information

Within the last decade, wireless networks have become integral to the day-to-day activities of mobile workers. Most organizations have realized the tremendous cost savings of using wireless networks by increasing worker productivity. In many cases, wireless networks have also proven to help reduce costs and increase the types of services provided by companies to their customers.

Wireless carriers have spent billions of dollars building out new third generation networks like GPRS, EDGE, 1xRTT, and 1xEvDO. 802.11 Wireless LANs are being proliferated around the world. There exist private RF networks like RD-LAP, EDACS, and conventional or trunked networks which are being used by millions of utility and public safety workers throughout the world. Finally, newer wireless networks like WiMax and UMTS are just beginning to be deployed to carriers and service providers.

One feature that exists on many wire line based networks that would have distinct advantages in the wireless world is broadcasting. Broadcasting is an efficient way to send a message to users when the same message should be sent to each user. Instead of sending an individual message to each user, a single message can be sent to all the users simultaneously. Many wire line applications, primarily in the multimedia space, currently take advantage of broadcasting capabilities using existing standards like multicasting.

In the various types of public safety, first responder and field force automation applications, broadcasting capabilities can improve the productivity of the mobile user. As an example, a single alert message can be broadcasted out to every mobile user to instantly alert them of a status or an appropriate action. A single broadcast is wireless efficient since only a single transmission will be used across the airwaves. By leveraging broadcasting capabilities, application providers can reduce the amount of wireless airtime used thereby providing more throughput and bandwidth for other application traffic.

Unfortunately, the problem of broadcasting over wireless networks is very complex. For one, not all wireless networks support broadcasting capabilities. Many is wireless networks are built to not allow broadcast traffic replicated through the network. Therefore, if an application supported broadcasts, it may have to turn the feature off for these non-broadcast aware networks. An application must then be required to understand which wireless infrastructure is used and then selectively activate broadcasting capabilities. If the application required modifications to detect whether the wireless network is broadcast aware, the application would require a significant investment in application development resources. In addition, the application would be custom and would not be network independent.

A second problem of broadcasting over wireless networks occurs when a mobile user is roaming between dissimilar wireless networks. Existing patents, such as U.S. Pat. No. 6,198,920, to DOVIAK et al. entitled “Intelligent Routing of Data between and Remote Device and a Host System” and U.S. Pat. No. 6,418,324, to DOVIAK et al. entitled “Apparatus and Method for Transparent Wireless Communication between a Remote Device and a Host System”, the disclosures of which are expressly incorporated by reference herein in their entireties, disclose improved simultaneous utilization of multiple networks. In these systems, users can seamlessly roam between dissimilar networks. Therefore, as a mobile worker moves out of range of the primary network, the worker can continue to communicate over a secondary wireless network. In the example of a mobile user roaming, the applications do not understand the characteristics of the wireless network and therefore would be unable to broadcast packets to the mobile users. Since the mobile users will be switching wireless networks, the application will not know where the messages should be broadcasted. In addition, the applications have the problem of understanding when the mobile user roams from a network that supports broadcasting to one that does not.

Although broadcasting capabilities over wireless networks would be very advantageous to wireless applications, building the specific broadcast capabilities into the wireless applications would be very expensive and make the applications wireless network specific. This would reduce the adoption of the wireless applications and more importantly make the applications very network dependent, thus slowing the general adoption of the wireless applications.

Therefore, a need exists to enable broadcasting capabilities over wireless networks. Moreover, a need exists for a system to automatically allow applications to leverage broadcasts by using standardized broadcasting methodology over wireless networks. In addition, there exists a need to be able to broadcast messages to a group of users when the users within the group are currently using different wireless networks. In addition, there exists a need to allow broadcasting capable applications to function over wireless networks that do not support broadcasting capability. Finally, a need exists for a system to provide broadcasting capabilities over multiple wireless networks, the broadcasting capabilities being transparent to the end user, application, and network infrastructure involve.

### SUMMARY OF THE INVENTION

In view of the foregoing, the present invention is directed to enabling applications to broadcast to mobile users on multiple networks, both wireless and wire line. The present invention, which may be embodied as multiple network broadcasting, allows a mobile data user to receive broadcasted packets regardless of the network currently being used.

According to an aspect of the present invention, a method is provided for broadcasting a packet to multiple recipients accessible only via multiple dissimilar wireless networks. The method includes determining whether the packet is to be broadcast, and when the packet should be broadcast, determining recipients of the packet. The method further includes selecting a first current network over which the packet will be broadcast, based upon the determined recipients, and selecting a second current network over which the packet will be broadcast, based upon the determined recipients. The method also includes sending the packet to the recipients accessible via the first current network; and sending the packet over the second current network to the recipients accessible via the second current network.

In one embodiment, the first current network and the second current network are selected from an allowable broadcast list, the allowable broadcast list being dynamically generated and including wireless networks configured to allow broadcasting. Optimizing can occur so that the allowable broadcast list first includes networks that natively support broadcasting and later include networks that do not natively support broadcasting. In one embodiment, the recipients are statically pre-configured.

In another aspect, a method is provided for broadcasting a packet to multiple recipients via a wireless network. The method includes determining whether the packet is to be broadcast; and when the packet is determined to be broadcast, determining recipients of the packet. The method further includes selecting a current network over which the packet will be broadcast, based upon the determined recipients, and determining whether the current network supports a type of broadcasting represented by the packet. When the current network does not support the type of broadcasting represented by the packet, the packet is converted from the type of broadcasting represented by the packet into a type of broadcasting supported by the network. The method further includes sending the packet to the recipients via the current network using the type of broadcasting supported by the network.

When the current network does not support any type of broadcasting, the converting includes replicating the packet for each recipient; and the sending includes sending the replicated packet individually to each recipient. The method may also include configuring the network not supporting the type of broadcasting represented by the packet, prior to receiving the packet.

A method is provided for broadcasting a packet over multiple dissimilar wireless networks, at least one of the networks not natively supporting broadcasting. The method includes determining whether the packet is to be broadcast; and when the packet should be broadcast, determining recipients of the packet. A current network over which the packet will be broadcast is then selected based upon the determined recipients. Subsequently, it is determined whether the current network supports broadcasting. When the current network does not natively support broadcasting, the packet is individually sent to each recipient over the current network. When the current network does natively support broadcasting, the packet is broadcast to the recipients over the current network.

The method may also include dynamically generating an allowable broadcast list, the allowable broadcast list including wireless networks configured to allow broadcasting, the current network being selected from the allowable broadcast list. The method may further include optimizing the allowable broadcast list to first include networks that natively support broadcasting and to later include networks that do not natively support broadcasting. The method may also include statically pre-configuring the recipients to be associated with a virtual broadcast address.

In still another aspect, a system is provided for broadcasting a packet to multiple recipients accessible only via multiple dissimilar wireless networks. The system includes a router that determines whether the packet is to be broadcast, and a broadcast system. The broadcast system receives the packet from the router when the packet should be broadcast, determines recipients of the packet, selects a first current network over which the packet will be broadcast, based upon the determined recipients, and returns a first packet to be broadcast to the router. The router sends the first packet to the recipients accessible via the first current network. The broadcast system also selects a second current network over which a second packet will be broadcast, based upon the determined recipients. The router also sends the second packet over the second current network to the recipients accessible via the second current network.

In yet another aspect, an apparatus is provided for broadcasting a packet to multiple recipients accessible only via multiple dissimilar wireless networks. The apparatus includes a determining system that determines whether the packet is to be broadcast; and a broadcast system that receives the packet from the router when the packet should be broadcast, the broadcast system determining recipients of the packet, selecting a first current network over which the packet will be broadcast, based upon the determined recipients, and returning a first packet to be broadcast to the router. The apparatus also includes a transmitter that sends the first packet to the recipients accessible via the first current network. The broadcast system selects a second current network over which a second packet will be broadcast, based upon the determined recipients, and the transmitter sends the second packet over the second current network to the recipients accessible via the second current network.

In yet another aspect, a computer readable medium storing a program is also provided for broadcasting a packet to multiple recipients accessible only via multiple dissimilar wireless networks. The medium includes a determining code segment that determines whether the packet is to be broadcast; and a recipient code segment that, when the packet is determined to be broadcast, determines recipients of the packet. The medium also includes a network selecting code segment that selects a first current network over which the packet will be broadcast, based upon the determined recipients and also selects a second current network over which the packet will be broadcast, based upon the determined recipients. The medium also includes a transmitting code segment that sends the packet to the recipients accessible via the first current network, and sends the packet over the second current network to the recipients accessible via the second current network.

The network selecting code segment can select the first current network and the second current network from an allowable broadcast list, the allowable broadcast list being dynamically generated and including wireless networks configured to allow broadcasting. The medium may also include an optimizing code segment that optimizes the allowable broadcast list to first include networks that natively support broadcasting and to later include networks that do not natively support broadcasting. The medium may also include a network configuration code segment that enables static pre-configuring of the recipients to be associated with a virtual broadcast address.

In still another aspect, computer readable medium stores a program for broadcasting a packet to multiple recipients via a wireless network. The medium includes a determining code segment that determines whether the packet is to be broadcast; and a recipient code segment that, when the packet is determined to be broadcast, determines recipients of the packet. The medium also includes a network selecting code segment that selects a current network over which the packet will be broadcast, based upon the determined recipients; and a network support code segment that determines whether the current network supports a type of broadcasting represented by the packet. The medium further includes a converting code segment that, when the current network does not support the type of broadcasting represented by the packet, converts the packet from the type of broadcasting represented by the packet into a type of broadcasting supported by the network; and a transmitting code segment that sends the packet to the recipients via the current network using the type of broadcasting supported by the network.

In another aspect, a computer readable medium stores a program for broadcasting a packet to multiple recipients via multiple dissimilar wireless networks, at least one of the networks not supporting broadcasting. The medium includes a determining code segment that determines whether the packet is to be broadcast; and a recipient code segment that, when the packet is determined to be broadcast, determines recipients of the packet. The medium also includes a network selecting code segment that selects a current network over which the packet will be broadcast, based upon the determined recipients; and a network support code segment that determines whether the current network supports broadcasting. The medium further includes a transmitting code segment that, when the current network does not support broadcasting, sends the packet individually to each recipient over the current network; and a broadcasting code segment that, when the current network does support broadcasting, broadcasts the packet to the recipients over the current network.

The medium may also include a list generating code segment that dynamically generates an allowable broadcast list, the allowable broadcast list including wireless networks configured to allow broadcasting, the current network being selected from the allowable broadcast list. The list generating segment can optimize the allowable broadcast list to first include networks that natively support broadcasting and to later include networks that do not natively support broadcasting. The medium may also include a network configuration code segment that enables static pre-configuring of the recipients to be associated with a virtual broadcast address.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 illustrates a general overview of broadcasting over multiple wireless networks, according to an aspect of the present invention;

FIG. 2 illustrates a schematic block diagram of various components of a broadcasting system, according to an aspect of the present invention;

FIG. 3 illustrates a block diagram that depicts software components, in accordance with an aspect of the present invention;

FIG. 4 illustrates an exemplary configuration screen, according to an aspect of the present invention;

FIG. 5 illustrates an exemplary static broadcast configuration screen, according to an aspect of the present invention;

FIG. 6 illustrates an exemplary network broadcast configuration screen, according to an aspect of the present invention;

FIG. 7 shows an example of an internal map data structure used to store the group broadcast configuration, according to an aspect of the present invention;

FIG. 8 shows an example of a process used to identify which mobile users are on which wireless networks and associating them with the most efficient wireless network, according to an aspect of the present invention; and

FIG. 9 shows an exemplary process for sending broadcast packets, according to an aspect of the present invention.

### DETAILED DESCRIPTION

Multiple network broadcasting allows an application to broadcast a message to mobile users regardless of the wireless network being used for each mobile user. The system will automatically receive the broadcasted message from the application and make the decision to broadcast it across the different wireless networks to the mobile users. The flexibility of the solution provides the capabilities of having different users on different wireless networks receive the same broadcasted packet from the application. In addition, even if some mobile users are not on a broadcast capable network, they will still be able to receive the broadcasted packet.

Broadcasting has been available on wire line systems using the Internet Protocol (IP) for many years. One of the simplest ways to leverage broadcasting is to use the broadcast address built into the Internet Protocol. An IP address consists of both a network ID and a host ID. The network ID identifies the unique network of which the machines are a member. The host ID is a unique address that specifies the individual machine. If the host ID is set to all binary 1's, then the address becomes a broadcast address. This address can then be used to send a directed message to every machine in the network ID.

As an example, if a network is created with the IP addresses between 192.168.1.0 and 192.168.1.255, then the broadcast address is 192.168.1.255 since the address 192.168.1 is defined to be the network ID. If an application wishes to send a message to all the computers within that network, the application can target the message to 192.168.1.255 and all the machines will receive the message.

Another popular form of broadcasting is using IP multicasting. While using the broadcast address as described above, only members of the network can receive the broadcasted packet. In IP multicasting, packets can be directed to users spread across separate physical networks. In addition, membership in the IP multicast group is dynamic. This means that a mobile user can join or leave the group at any time. The dynamic nature of multicasting makes it a preferable method for broadcasting data to multiple users.

The above two methods described for sending broadcasted packets have significance because an aspect of the present invention leverages standards to enable broadcasting over wireless networks. In addition to the two features described above, another method can be used by application providers. In this embodiment, a method is provided for statically configuring the members of each group and assigning a virtual IP address to this broadcast group. Any packets destined for the virtual IP address will automatically be broadcasted to all users within the group.

While the disclosed system describes three main types of methods for generating broadcasts, any method can be provided to generate the messages that are broadcasted. For example, another embodiment may define an API that is used by application providers to submit broadcasted packets to the system. In other embodiments, an application might target a specific IP address and port number to submit the broadcasted packet to the system. The system will ensure those packets are broadcasted in the most efficient way possible to all users regardless of location of users.

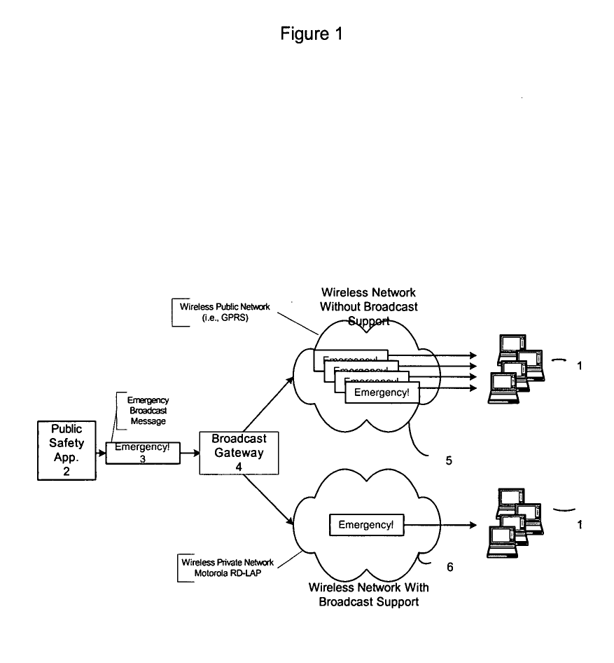

FIG. 1 shows an example of using broadcasting to send an emergency notification to the mobile users 1. A public safety application 2 will generate the “Emergency!” broadcast message 3. The message 3 will flow into the broadcast gateway 4 which will be responsible for delivering the message 3 to all the users 1. The broadcast gateway 4 understands which users 1 belong to which group and also which users 1 are currently associated with which wireless networks 5, 6. The broadcast gateway 4 will then automatically forward the data 3 over the different wireless networks 5, 6 in the format required by the network 5, 6. As the example shows, the wireless private network 6 supports a broadcasting capability and therefore, the networks native broadcast capabilities will be used. However, the wireless public network 5 does not support broadcasting. Therefore, the broadcast gateway 4 will manually replicate the packet 3 to each mobile user within the group 1 accessible via network 5. The above functionality is trans

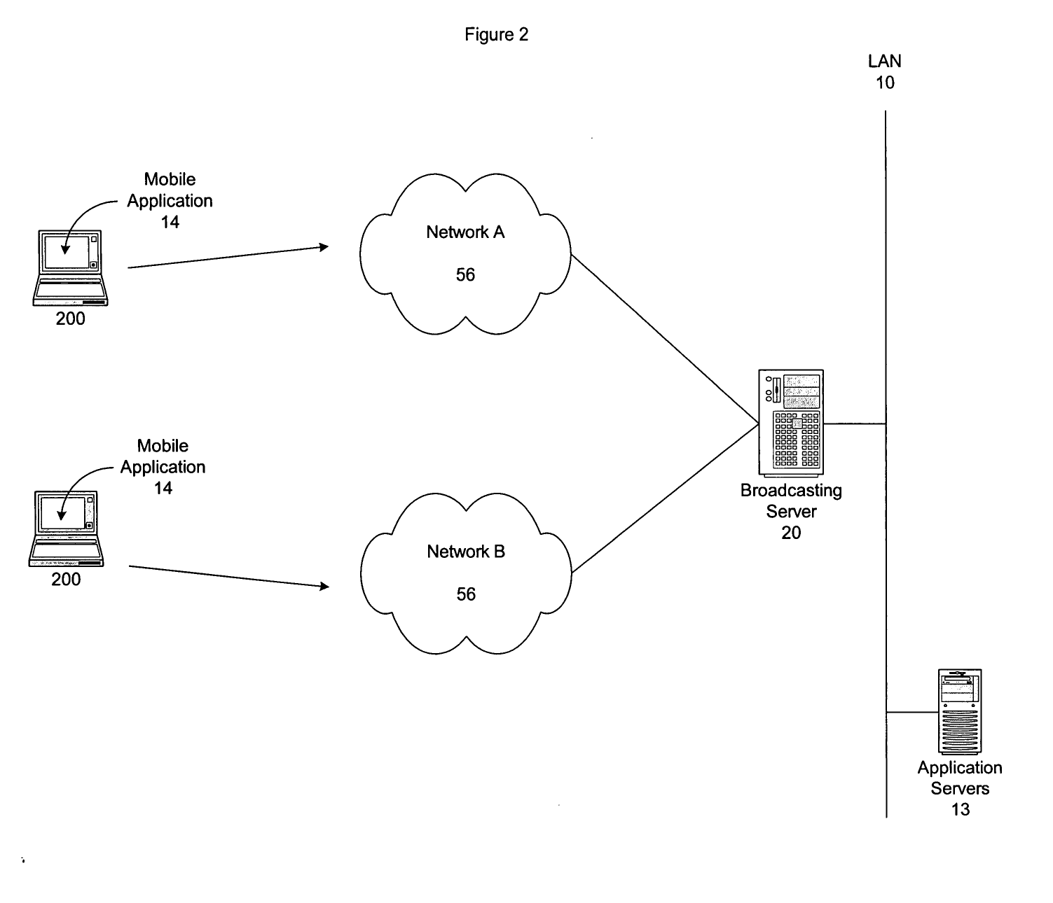

FIG. 2 shows a detailed view of an architecture that supports broadcasting. Application servers 13 are located on a LAN 10 to generate the broadcasted traffic. The application servers 13 must be connected to the broadcasting server 20 that is responsible for replicating the packet across the wireless networks 56. Mobile computers 200 register with the broadcasting server 20 so the broadcasting server 20 knows which wireless network 56 the users are registered on. Finally, a mobile application 14 is responsible for receiving the broadcasted packet and processing it. Exemplary embodiments of the mobile application 14 include a public safety application that displays emergency alerts or a multimedia application that displays a video or audio stream.

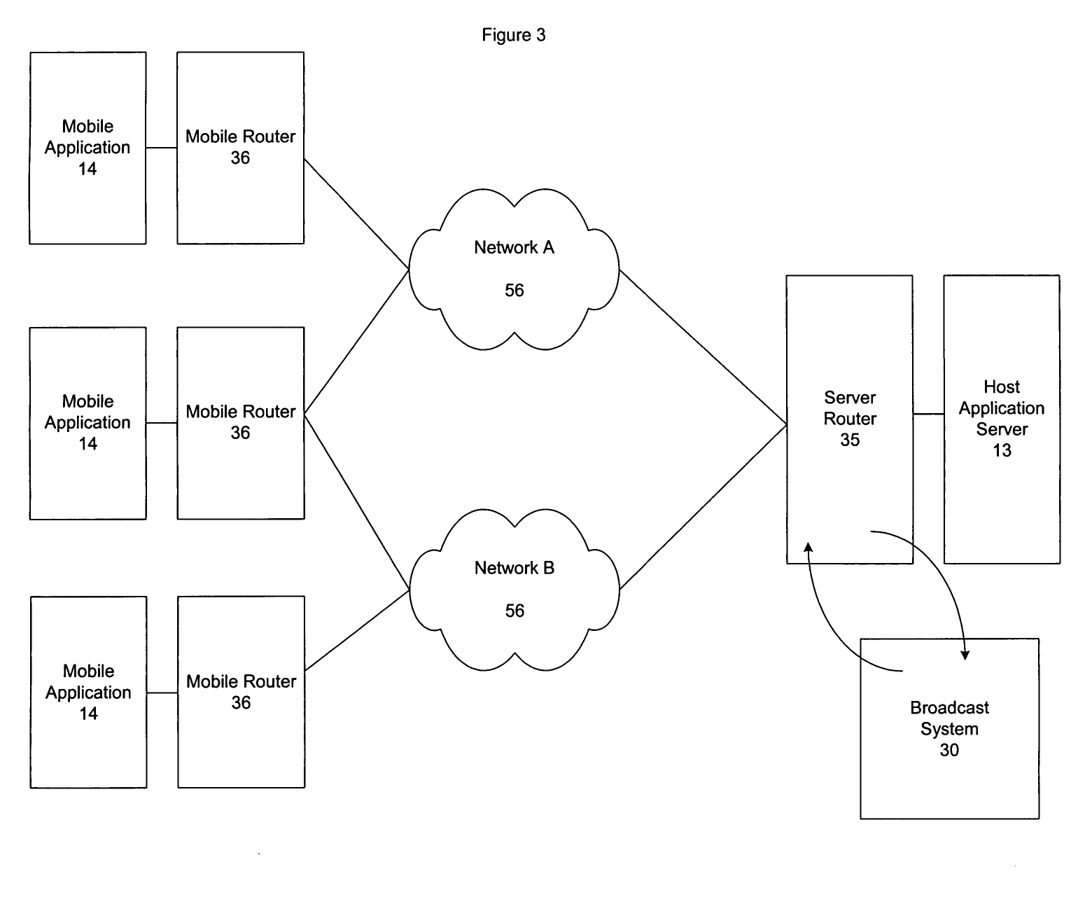

Multiple network broadcasting is normally used in conjunction with a wireless router. An exemplary router is described in U.S. Pat. Nos. 6,198,920 and 6,418,324 discussed above, the disclosures of which are expressly incorporated by reference herein in their entireties. FIG. 3 shows an example of communications between a host side router 35 (i.e., server router 35) and a broadcasting system 30. The server router 35 can operate as a standard router; however, if certain traffic is required to be broadcasted through the broadcast system 30, then the data is forwarded to the broadcast system 30. The overall system also includes a mobile application 14, a mobile router 36, and a host application residing on an application server 13.

When packets flow through the server router 35, the server router 35 decides whether the data should be sent through the broadcast system 30, in which case the server router 35 passes the data to the broadcast system 30 for processing. Once the broadcast system 30 finishes processing the data for transmission over the multiple networks 56, the broadcast system 30 then passes the data back to the server router 35 for eventual delivery over the networks 56. The communication between the server router 35 and the broadcast system 30 is via the well-known IPC (inter-process communication).

The server router 35 should understand when networks go in or out of range. This functionality is described in previous patents like U.S. Pat. Nos. 6,198,920, and 6,418,324, discussed above, the disclosures of which are expressly incorporated by reference herein in their entireties. This network status information is important for the server router 35 because it is required to dynamically change its broadcast behavior in response to dynamic changes of the network status.

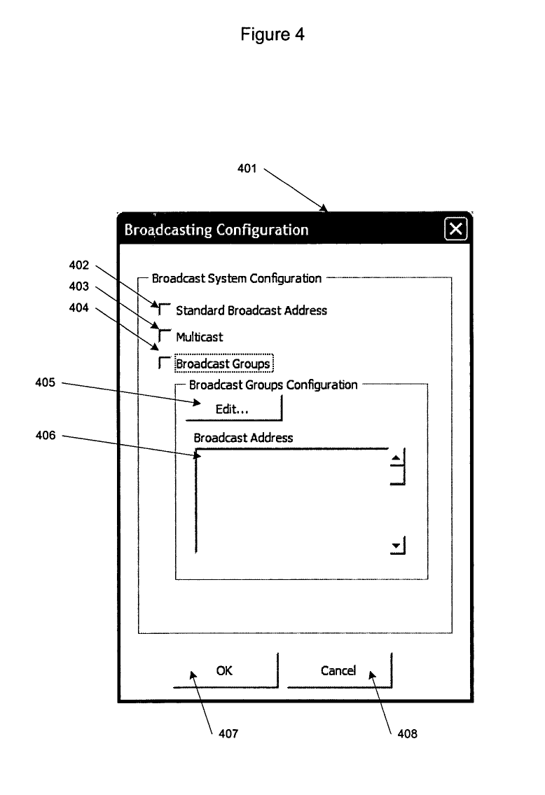

The broadcast system 30 requires a configuration interface to provide control to system administrators to alter the behavior of the broadcast system 30. The configuration functionality described below can be located on the broadcast system 30. If the operating system on the broadcast system 30 provides a graphical user interface, the configuration can be performed using a graphical application residing on the broadcast system 30. One exemplary type of configuration interface 400 is depicted in FIG. 4. If the broadcasting software is installed on a device without a graphical user interface, then some other means will be required to receive the broadcast configuration. An example is a configuration interface that receives configuration packets at a UDP port over the networks or accepts configuration via a downloaded file.

As shown in FIG. 4, the user can set up the various options associated with the broadcasting capability. For example, the user can have the option to specify which type of broadcast packets it will accept:
Standard Broadcast Address 402—This parameter specifies whether the broadcast system 30 will accept standard IP broadcast packets to be broadcasted to the mobile users.
Multicast 403—This parameter specifies whether the broadcast system 30 will accept multicast packets and process multicast packets accordingly.
Broadcast Groups 404—This parameter specifies whether the broadcast system 30 will accept broadcast groups. Since the Broadcast Groups parameter requires statically defined groups, a mechanism for entering statically defined groups is identified below.

The above three broadcast packets types are most commonly used for broadcasting. Other embodiments may introduce new types of broadcast packets from the host application. For example, an alternative embodiment includes an IP address and port combination that is associated with a particular broadcast group. Anytime a packet is received for the IP address and port combination, it will be broadcasted to all members of the group. Yet another embodiment includes other user identifiers instead of IP addresses. For example, MAC addresses or hostnames may be used to identify the members of the broadcast group. While the broadcast packet format may change, the current system can still be used to replicate those broadcast packets across the different wireless networks. The configuration screen 400 may have to change to reflect the new settings of the new broadcast format packet.

When the system administrator selects the Broadcast Groups 404, the graphical user interface will provide a method of entering statically defined group information. One embodiment employs an Edit button 405 that will bring up a separate Static Broadcast Configuration screen 501. The screen 401 also shows a list 406 that summarizes the configuration information. The list 406 contains a virtual broadcast address. The broadcast address represents a virtual IP address that is assigned to a group of users. To display the selected list of all machines that are assigned to the group, the administrator can select a virtual IP address and press the Edit button 405. Finally, OK 407 and Cancel 408 buttons are provided to accept changes or reject changes.

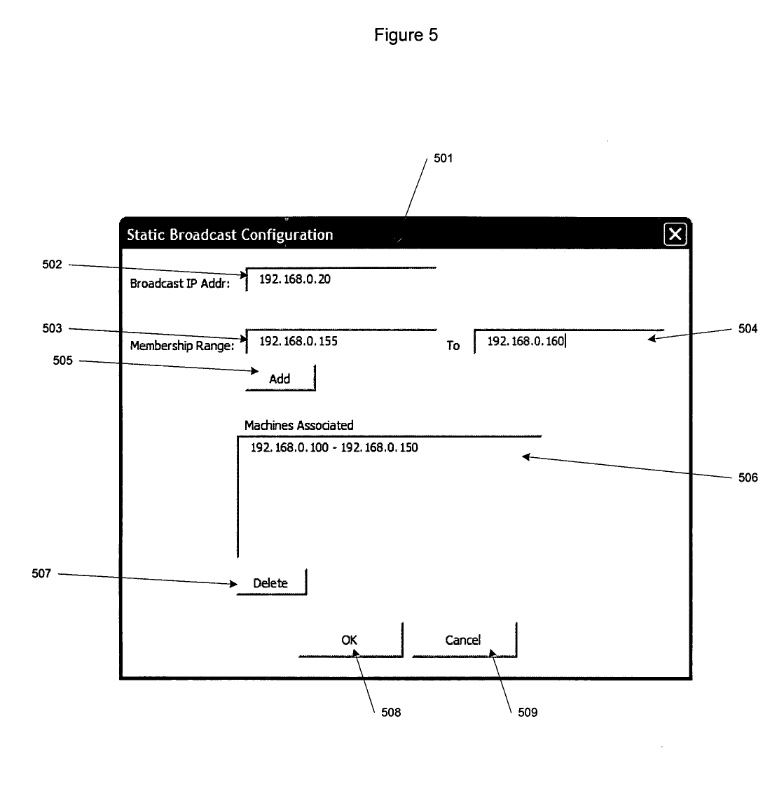

Referring to FIG. 5, a Static Broadcast Configuration 501 screen allows the administrator to enter information about the static broadcast groups. The Broadcast IP Address field 502 specifies the virtual IP address assigned to the broadcast group. Any IP packet that targets this virtual IP address will be automatically broadcasted to all users within the group. The Membership Range fields 503 and 504 can be used to enter a range (or multiple ranges) of IP addresses. The Add button 505 is used to add the IP addresses to the broadcast group. The Machines Associated list 506 displays all the IP addresses that are assigned to the group. A mechanism is provided to delete a range from the group box. For example, a Delete button 507 can be pressed after the appropriate range is selected. Finally, OK 508 and Cancel 509 buttons are provided to accept the changes or reject the changes.

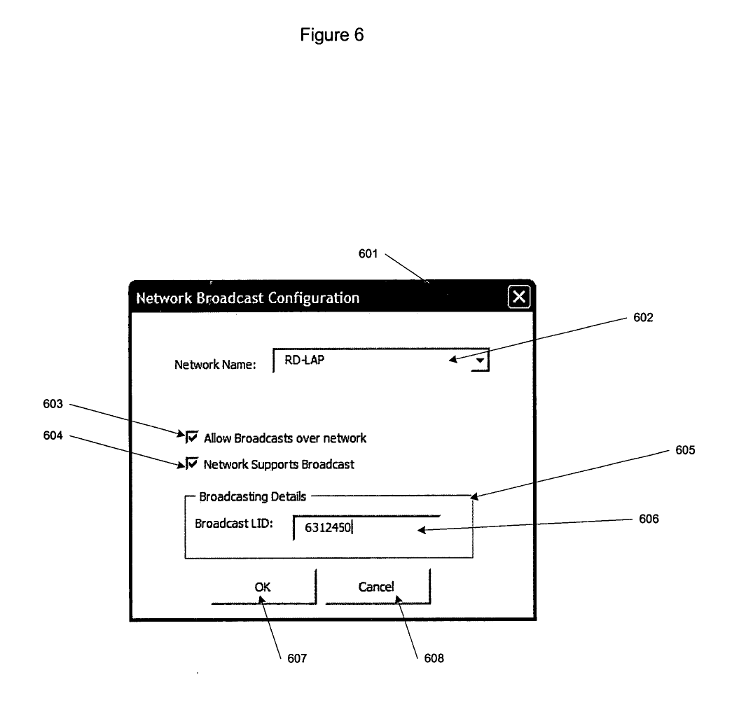

In addition to the broadcast configuration, the system also requires configuration for each network within the system. A screen is provided similar to screen 601 (shown in FIG. 6) that supplies the capability for configuration of the network parameters. A Network Name field 602 allows the user to select the appropriate network that will be configured within the system. Once the user selects the network name, the following parameters can be modified for each network:
Allow Broadcasts over Network 603—The Allow Broadcasts over Network configuration allows the administrator to enable or restrict broadcasts over the selected network. Therefore, this parameter can restrict the propagation of broadcasts over networks.
Network Supports Broadcast 604—The Network Supports Broadcast configuration allows the administrator to specify if the network natively supports broadcasts. If the network does not natively support broadcasts then the broadcasting system would replicate any broadcast message to the mobile users registered on the network. If the network supports broadcasting, then it may be required to enter a set of configuration parameters for the network.
Broadcasting Details 605—If a network natively supports broadcasts, then the network may require certain configuration parameters specifically for broadcasts. For example, an RD-LAP Logical Identifier (LID) 606 may be required to be configured to send broadcast packets across the RD-LAP network. While this example only uses an LID, the network may require other items as well and this configuration item would be modified to reflect the appropriate information.

Finally, OK 607 and Cancel 608 buttons can be provided to save the configuration or cancel the changes.

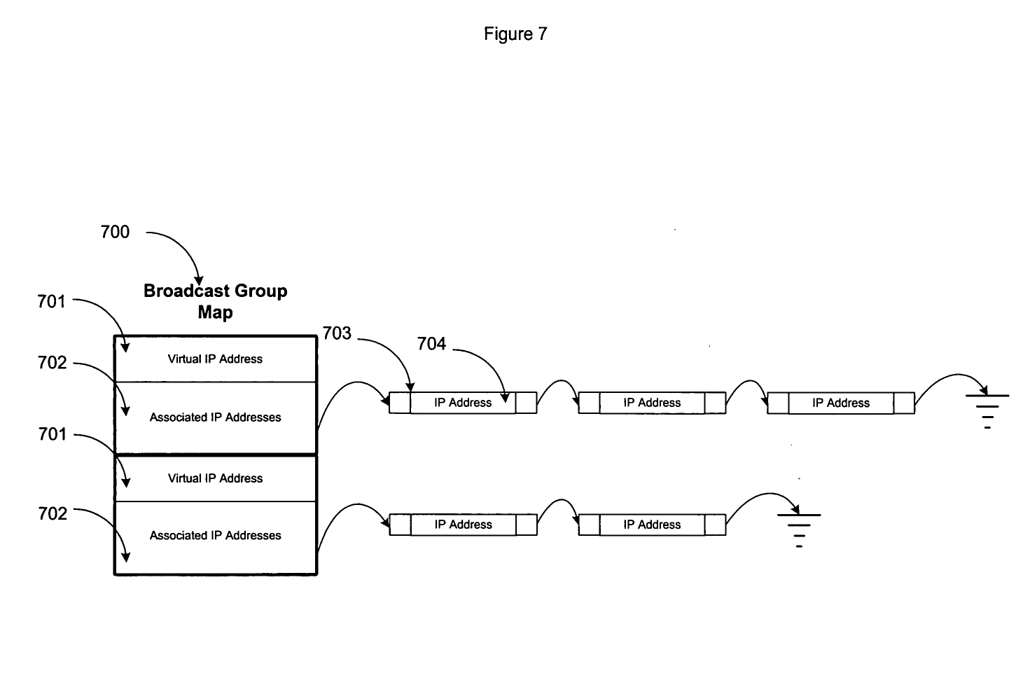

FIG. 7 shows an example of a map storage structure 700 used to store the broadcast group configuration. A map 700 is a data structure object that contains a list of key/value pairs. A map 700 cannot contain duplicate keys, and each key can map to one value only. While other well-known data structures, like arrays, stacks, queues, or linked lists can be used, a map 700 provides the best performance for the type of functionality required by broadcasting. The map 700 is keyed off the broadcast IP address and therefore field 701 stores each broadcast IP address in the broadcast group configuration. In each map entry is a structure storing various pieces of data. The structure will be a linked list 703 of data objects 704 related to the broadcast configuration and a header 702. FIG. 7 shows an example of each IP address of the broadcast group stored in each element of the map data structure:
IP address 704—This entry stores a unique IP address of each mobile device that is associated with the broadcast group.

While FIG. 7 describes a data structure used to store IP addresses related to a separate group, the system envisions multiple data structures used to store information about the different broadcast types. Therefore, in the described system a map data structure for the broadcast group configuration and then another map data structure for the multicast group configuration are also provided. The above data structure can be used to store any type of group of identifiers associated with an appropriate broadcast group. Thus, the present invention is not limited to categorizing groups by IP addresses.

In one embodiment such as that illustrated in FIGS. 2 and 3, the broadcast system 30 exists only on the host side. Therefore, any traffic that is broadcasted from the host 13 would first reach the broadcast system 30 before being sent outbound to the mobile applications 14. In this configuration, if a broadcast packet is generated by the mobile client 200, then it would first forward the packet to the broadcast system 30, and then the broadcast system 30 would replicate the broadcast. This architecture has the advantage of not requiring the broadcast system 30 to exist on all the mobile clients 200.

An alternate embodiment would allow the broadcast system 30 to exist on both the mobile clients 200 and on the host side. This would also require each mobile user to have its own configuration settings. This architecture allows the mobile client 200 to broadcast directly to other users instead of first forwarding to the host side. Therefore, if a broadcasted packet was generated by the mobile client 200, then the mobile client 200 would replicate it directly to all the users associated with the broadcasted packet instead of first sending it to the host side.

Process Flow

An exemplary flow of data through the broadcast system is now described.

Initialization

Upon startup of the broadcasting system, the system will first initialize any internal storage variables. There will be, at a minimum, an Allowable Broadcast List (ABL). The ABL is created dynamically and is based upon the available wireless networks configured in the system. The ABL will initially store the name of all wireless networks that are currently configured in the system. As an optimization function, the initialization routine will remove any network that is configured to not allow broadcasts. If the main system ever modifies its network configuration, the ABL will be re-evaluated to determine if any networks require adding or removal.

The ABL will then be sorted to provide optimization for the broadcasting system. The ABL will initially be sorted by broadcast capability. Natively supported broadcast capable networks will be ranked higher than networks that do not natively support broadcasting. This sort will ensure that all networks that natively support broadcasts will be pushed to the top of the list. This will provide an optimization technique where anytime the broadcasted messages are sent, they will be broadcasted to the user in the most efficient way possible for that appropriate network.

A second sort will then occur to prioritize each network within a broadcast capability subgroup. Therefore, all broadcast capable networks will be sorted to place the preferred network at the top the list. This preferred network status can be determined in various ways. One way is to statically configure the priority of each network. Therefore, the networks with the highest priority will be placed at the top of the list. The other option is to dynamically sort the networks on basis of throughput. Therefore, the highest throughput network will be the network at the top of the list. Yet another option is to sort the networks based upon the costs of the network. The least cost network will be pushed to the top of the list. In addition, the system can also employ a combination of the above three sort options. In an embodiment, the disclosed system will receive the network priorities from the router. After the data is sorted, the ABL will be a single list arranged from most preferred networks to least preferred network.

The system will then initialize the data structures for storing the broadcast group definitions. In the examples disclosed, there will be at least two map data structures created. One will be created for the broadcast group configuration and another will be created for the multicast group configuration.

Since the multicast group configuration will be dynamically built, it will be initialized to contain zero entries. However, the broadcast group map data structure can be initialized to contain the configured settings. The broadcast system will read all settings from the broadcast group configuration entries and enter the data into the broadcast group map data structure.

Finally, since the broadcast system is normally used in conjunction with a wireless router, the broadcast system would register with the router which packets are defined as broadcast packets. One example that can be used is the registration of the appropriate addresses with the router. In this example, the broadcast system will register the appropriate packet identifier (e.g., IP address) to the router. This will allow the router to automatically forward packets meeting these criteria to the broadcast system when they are received.

After initialization completes, the broadcast system will start its main processing functionality.

Main Processing

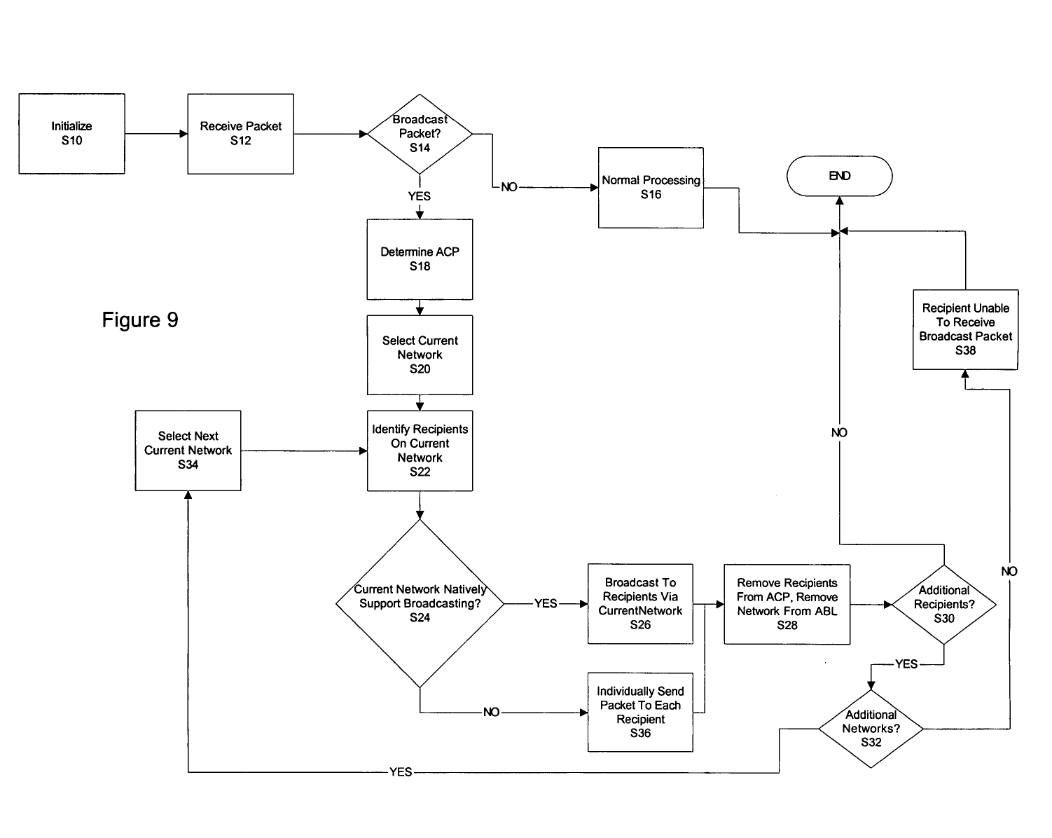

Referring to FIG. 9, after initialization at step S10, the router will begin to listen to packets arriving at the broadcast server at step S12. If a received packet matches any of the types of broadcast packets outlined in the configuration, then the packet will be passed to the broadcasting system for processing (S14:YES). If the packet does not match any of the types of broadcast packets (S14:NO), then the router will continue to process the packet at step S16 and the process ends. The packet will be passed to the broadcast system using a well-known method like IPC. If the system has any other rules that provide filtering capabilities, like Port Routing functionality as disclosed in U.S. patent application Ser. No. 10/084,049 to Whitmore et al. filed on Feb. 28, 2002, which published as U.S. Patent Application Publication No. 2002/122394, the disclosure of which is expressly incorporated by reference herein in its entirety, then the rules will be evaluated to determine if any broadcast type packet has been denied. In this case, the packets may be filtered to not allow broadcast type traffic.

If a valid broadcast packet is received, then the broadcast system will first create an Applicable Client Population (ACP) list at step S18. The Applicable Client Population is a list of all the mobile users that would be associated with the broadcast packet. In an embodiment the list contains at least an IP address, but alternate implementations can be expanded to include other identifiers as well. For example, an embodiment may use MAC addresses as the client identifiers instead of IP addresses. The ACP can be stored in any applicable data structure. As an additional optimization technique, the ACPs can be statically configured in the initialization process. This would have the advantage of not requiring the lists to be dynamically built as each broadcast packet is received by the system

The creation of the ACP will be based upon the type of broadcast packet received. If the received packet is a standard broadcast packet, then the ACP will be the entire population of computers within the subnet. For example, if a packet is received with the broadcast address of 192.168.1.255, then this will resolve to all computers and devices between 192.168.1.1 and 192.168.1.254. Since the host part of the IP address is 255, this number will be replaced by all values between 1 and 254 and the resulting list will make up the ACP. As another example, if a broadcast packet is received with the IP address of 192.168.255.255, then the host IDs will be replaced with all numbers between 1 and 255. Therefore, the ACP will consist of 192.168.0.1 to 192.168.255.254.

If a received broadcast packet matches a broadcast group packet, it means it has a virtual IP address configured in the broadcast group configuration. The broadcast system will search for the appropriate virtual IP address within the broadcast group map table. Once the appropriate entry is located, the ACP will be comprised of all IP addresses within the list associated with the broadcast IP address.

Finally, if the broadcast packet falls within the multicast address range, then the ACP will consist of all machines that have dynamically joined the multicast group. The multicast protocol is a well-known technology that is defined via RFC 1112 and RFC 2236, the disclosures of which are expressly incorporated by reference herein in their entireties, and will not be discussed within this specification. However, mobile clients who wish to join the multicast group would generate packets based upon the IGMP protocol. The broadcast system would intelligently monitor the IGMP traffic and any time groups are created, the broadcast system would keep track of the machines associated with the multicast groups. The list of users that are presently registered for a specific multicast group will be used to populate the ACP if a multicast broadcast packet is received for that group. Similar to the broadcast group configuration, the broadcast system will search for the appropriate multicast IP address within the multicast group map table. In addition, the broadcast system would also be required to implement IGMP, as defined in the relevant RFCs, to notify routers within the infrastructure that the broadcast server can process multicast traffic. Once the appropriate entry is located, the ACP will be comprised of IP addresses within the list associated with the multicast IP address.

The broadcast system is now ready to start sending the packets to the mobile users. The broadcast system will begin to iterate through the ABL. The system will choose the first wireless network in the ABL at step S20. This network shall be called the current broadcast network. The system will then identify all users within the ACP that are associated with the current broadcast network at step S22. It normally does this by looking at the routing table used by the router. The routing table serves as a cross reference between each mobile user and wireless network on which the user is currently registered. The routing table is typically managed by the router. The comparison returns any mobile user that is currently registered on the current broadcast network.

For each user currently registered on the current broadcast network, the broadcast system will send the packet to the user. Depending on the type of wireless network the broadcast system determines which method is used for broadcasting the packets at step S24. If the selected wireless network provides native broadcast support (S24:YES), then the packets will be broadcasted to the mobile users according to the method required by the wireless network at step S26. It will normally do this by creating a new packet that will be broadcasted to the mobile users. It will also do this by leveraging the broadcasting configuration details 605 that were entered by the administrator. In most cases, a new data packet will be created according to the parameters associated in the broadcasting configuration details 605. The data payload of this new packet will consist of the original broadcasted packet. Thus, if the network does not support the type of broadcasting represented by the packet, then the broadcast system converts from the broadcast type represented by the packet into the broadcast type supported by the network. If the wireless network does natively support broadcasts, then all users currently registered on that network will be removed from the ACP and the current broadcast network will be removed from the ABL after the native broadcast packet is transmitted through the network at step S28.

If the selected wireless network does not natively support broadcasts (S24:NO), then the broadcasting system will iterate through each remaining user currently on the network and send the packet individually to each user at step S36. It will create a new packet and then add the original broadcasting packet to the data payload of the new packet. After a packet is sent to each user, that user is removed from the ACP at step S28. After the packet is sent to all users on the current network, the current network is removed from the ABL at step S28.

The broadcast system will not send the packets directly to the mobile user. Instead, after it creates the new broadcasted packet, it will send the packet back to the router for eventual delivery to the mobile user through the current network. The broadcast system will use standard IPC for communication with the Router.

After the broadcasts are sent to all users associated with the current broadcast network, those users are removed from the ACP at step S28. In addition, the current broadcast network is removed from the ABL as well, at step S28. From here the broadcast system will determine if additional recipients exist in the ACP at step S30. If so (Step S30:YES), and if additional networks are in the ABL (S32:YES) the process chooses the next wireless network from the ABL at step S34. The process will then continue from step S22 until all wireless networks are removed from the ABL. If mobile users are left in the ACP without any remaining networks in the ABL (S32:NO), then these mobile users will not be able to be served via broadcasting (S38) and the process ends. Therefore, the messages will not be replicated to these mobile users. If there are no additional recipients (S30:NO), the process ends.

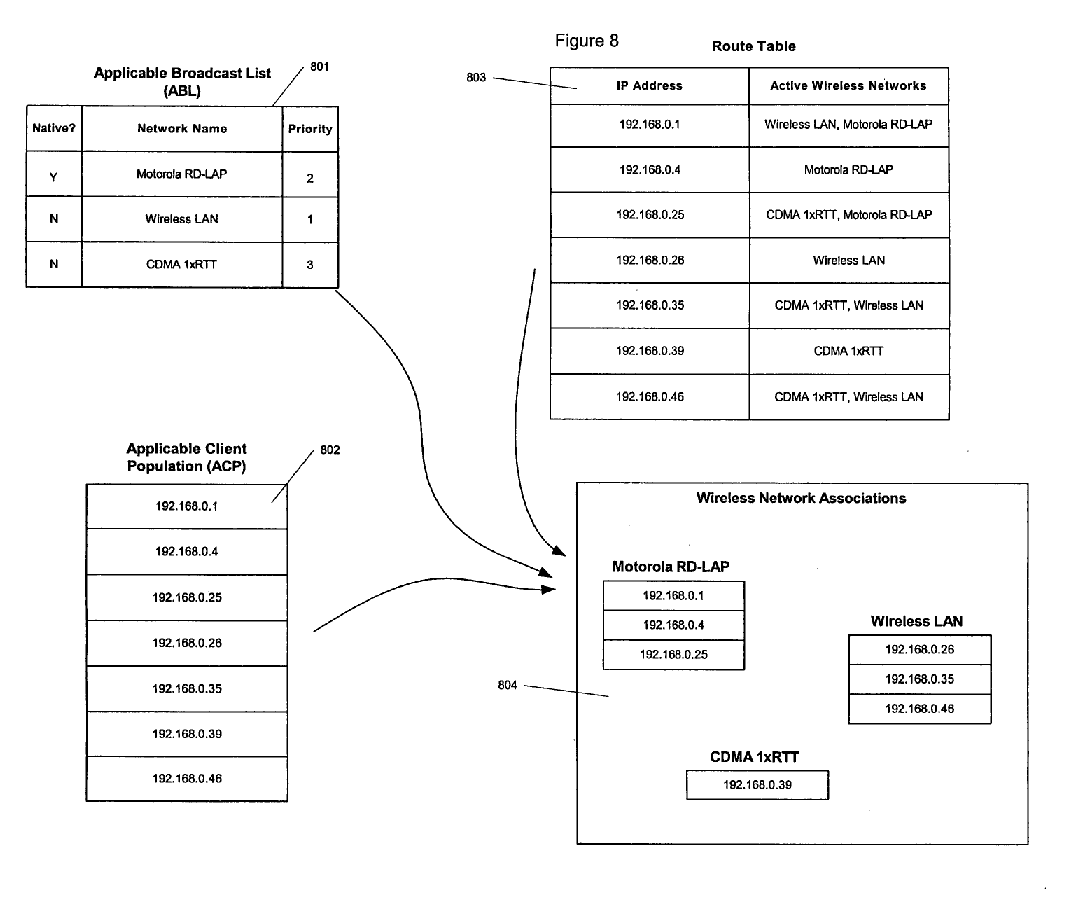

FIG. 8 shows an example of how the above mentioned process functions. The ABL 801 is created from the wireless networks installed in the system. The ACP 802 is created after the broadcast packet has been received. Finally, the Route Table 803 is provided by the router. After the above flow is executed, the broadcast system will create a grouping of wireless networks and users associated with them. This grouping 804 ensures that networks that support native broadcasts are used before networks that do not support native broadcasts. In the case that a mobile user is associated with both, the more optimized network will be used for communication.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. For example, the present invention is not limited to environments in which some networks support broadcasting and other networks do not support broadcasting. If recipients are not accessible via a single network, the present invention applies regardless of whether the networks support broadcasting. Moreover, if the network does not support the type of broadcasting represented in the received packet (or any type of broadcasting), the present invention also applies.

Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., IP version 4, IP version 6, UDP/IP, TCP/IP, ICM), and wireless networking (802.11a, 802.11b, 802.11g, CDMA 1xRTT, CDMA 1xEVDO, GSM, CDPD, GPRS, EDGE, UMTS, RD-LAP, SMR, LMR) represent examples of the state of the art. Such standards are periodically superseded by faster or more efficient equivalents having essentially the same functions. Accordingly, replacement standards and protocols having the same functions are considered equivalents.

What is claimed:

1. A method for broadcasting a packet to multiple recipients accessible only via multiple dissimilar wireless networks, the method comprising:
determining whether the packet is to be broadcast;
when the packet is determined to be broadcast, determining recipients of the packet;
selecting a first current network over which the packet will be broadcast, based upon the determined recipients;
sending the packet to the recipients accessible via the first current network;
selecting a second current network over which the packet will be broadcast, based upon the determined recipients; and
sending the packet over the second current network to the recipients accessible via the second current network.

2. The method of claim 1, further comprising selecting the first current network and the second current network from an allowable broadcast list, the allowable broadcast list being dynamically generated and including wireless networks configured to allow broadcasting.

3. The method of claim 2, further comprising optimizing the allowable broadcast list to first include networks that natively support broadcasting and to later include networks that do not natively support broadcasting.

4. The method of claim 1, in which the recipients are statically pre-configured.

5. A method for broadcasting a packet to multiple recipients via a wireless network, the method comprising:
determining whether the packet is to be broadcast;
when the packet is determined to be broadcast, determining recipients of the packet;
selecting a current network over which the packet will be broadcast, based upon the determined recipients;
determining whether the current network supports a type of broadcasting represented by the packet;
when the current network does not support the type of broadcasting represented by the packet, converting the packet from the type of broadcasting represented by the packet into a type of broadcasting supported by the network; and
sending the packet to the recipients via the current network using the type of broadcasting supported by the network.

6. The method of claim 5, in which the current network does not support any type of broadcasting,
wherein the converting comprises replicating the packet for each recipient; and
wherein the sending comprises sending the replicated packet individually to each recipient.

7. The method of claim 5, further comprising configuring the network not supporting the type of broadcasting represented by the packet, prior to receiving the packet.

8. A method for broadcasting a packet to multiple recipients via multiple dissimilar wireless networks, at least one of the networks not supporting broadcasting, the method comprising:
determining whether the packet is to be broadcast;
when the packet is determined to be broadcast, determining recipients of the packet;
selecting a current network over which the packet will be broadcast, based upon the determined recipients;
determining whether the current network supports broadcasting;
when the current network does not support broadcasting, sending the packet individually to each recipient over the current network;
when the current network does support broadcasting, broadcasting the packet to the recipients over the current network.

9. The method of claim 8, further comprising dynamically generating an allowable broadcast list, the allowable broadcast list including wireless networks configured to allow broadcasting, the current network being selected from the allowable broadcast list.

10. The method of claim 9, further comprising optimizing the allowable broadcast list to first include networks that natively support broadcasting and to later include networks that do not natively support broadcasting.

11. The method of claim 8, further comprising statically pre-configuring the recipients to be associated with a virtual broadcast address.

12. A system for broadcasting a packet to multiple recipients accessible only via multiple dissimilar wireless networks, the system comprising:
a router that determines whether the packet is to be broadcast;
a broadcast system that receives the packet from the router when the packet should be broadcast, the broadcast system determining recipients of the packet, selecting a first current network over which the packet will be broadcast, based upon the determined recipients, and returning a first packet to be broadcast to the router;
wherein, the router sends the first packet to the recipients accessible via the first current network;
wherein the broadcast system selects a second current network over which a second packet will be broadcast, based upon the determined recipients; and
wherein the router sends the second packet over the second current network to the recipients accessible via the second current network.

13. An apparatus for broadcasting a packet to multiple recipients accessible only via multiple dissimilar wireless networks, the apparatus comprising:
a determining system that determines whether the packet is to be broadcast;
a broadcast system that receives the packet from the router when the packet should be broadcast, the broadcast system determining recipients of the packet, selecting a first current network over which the packet will be broadcast, based upon the determined recipients, and returning a first packet to be broadcast to the router;
a transmitter that sends the first packet to the recipients accessible via the first current network;
wherein the broadcast system selects a second current network over which a second packet will be broadcast, based upon the determined recipients; and
wherein the transmitter sends the second packet over the second current network to the recipients accessible via the second current network.

14. A computer readable medium storing a program for broadcasting a packet to multiple recipients accessible only via multiple dissimilar wireless networks, the medium comprising:
a determining code segment that determines whether the packet is to be broadcast;
a recipient code segment that, when the packet is determined to be broadcast, determines recipients of the packet;
a network selecting code segment that selects a first current network over which the packet will be broadcast, based upon the determined recipients and also selects a second current network over which the packet will be broadcast, based upon the determined recipients; and
a transmitting code segment that sends the packet to the recipients accessible via the first current network, and sends the packet over the second current network to the recipients accessible via the second current network.

15. The medium of claim 14, in which the network selecting code segment selects the first current network and the second current network from an allowable broadcast list, the allowable broadcast list being dynamically generated and including wireless networks configured to allow broadcasting.

16. The medium of claim 15, further comprising an optimizing code segment that optimizes the allowable broadcast list to first include networks that natively support broadcasting and to later include networks that do not natively support broadcasting.

17. The medium of claim 14, further comprising a network configuration code segment that enables static pre-configuring of the recipients to be associated with a virtual broadcast address.

18. A computer readable medium storing a program for broadcasting a packet to multiple recipients via a wireless network, the medium comprising:
a determining code segment that determines whether the packet is to be broadcast;
a recipient code segment that, when the packet is determined to be broadcast, determines recipients of the packet;
a network selecting code segment that selects a current network over which the packet will be broadcast, based upon the determined recipients;
a network support code segment that determines whether the current network supports a type of broadcasting represented by the packet;
a converting code segment that, when the current network does not support the type of broadcasting represented by the packet, converts the packet from the type of broadcasting represented by the packet into a type of broadcasting supported by the network; and
a transmitting code segment that sends the packet to the recipients via the current network using the type of broadcasting supported by the network.

19. A computer readable medium storing a program for broadcasting a packet to multiple recipients via multiple dissimilar wireless networks, at least one of the networks not supporting broadcasting, the medium comprising:
a determining code segment that determines whether the packet is to be broadcast;
a recipient code segment that, when the packet is determined to be broadcast, determines recipients of the packet;
a network selecting code segment that selects a current network over which the packet will be broadcast, based upon the determined recipients;
a network support code segment that determines whether the current network supports broadcasting;
a transmitting code segment that, when the current network does not support broadcasting, sends the packet individually to each recipient over the current network;
a broadcasting code segment that, when the current network does support broadcasting, broadcasts the packet to the recipients over the current network.

20. The medium of claim 19, further comprising a list generating code segment that dynamically generates an allowable broadcast list, the allowable broadcast list including wireless networks configured to allow broadcasting, the current network being selected from the allowable broadcast list.

21. The medium of claim 20, in which the list generating segment optimizes the allowable broadcast list to first include networks that natively support broadcasting and to later include networks that do not natively support broadcasting.

22. The medium of claim 19, further comprising a network configuration code segment that enables static pre-configuring of the recipients to be associated with a virtual broadcast address.
